(19) United States
(12) Patent Application Publication
(10) Pub. No.: US 2008/0163755 A1
(43) Pub. Date: Jul. 10, 2008

(54) Wine Tank and Method of Use

(76) Inventor: Chris Diaz, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 12/053,297

(22) Filed: Mar. 21, 2008

Related U.S. Application Data
(62) Division of application No. 10/439,500, filed on May 15, 2003.

(51) Int. Cl. C12G 1/022

(52) U.S. Cl. 99/276

(57) ABSTRACT

A substantially cylindrical wine tank is adapted for direct transfer of fermented must to a press or other vessel by providing fork lift skids below the tank and vertical planar sides for receiving a fork lift apparatus modified for lifting and dumping rectangular fruit bins.

### CROSS REFERENCE TO RELATED APPLICATIONS

The present application is a Division of the co-pending US patent application for a “A Wine Tank and Method for Use”, filed on May 15, 2003, having application Ser. No. 10/439,500, which is incorporated herein by references.

### BACKGROUND OF INVENTION

The present invention relates to vessels or tanks used for the storage and fermentation of grapes or other fruits into wine.

As many types of wine benefit from the controlled contact of the initially crushed grapes with the juice, a mixture known as “must”. Thus, crushing grapes to release the juice and pressing the resulting must to extract the liquid are separate operations.

However, at some point in the production or fermentation process the juice or wine is separated from the skins and other solids such grape seeds and grape stems. In the case of red wines pressing the must, occurs after the conversion of sugars to alcohol is substantially complete. In the case of white wines, the skin contact time may be limited to several hours' merely to extract additional flavoring components therefrom.

Accordingly, the wine industry has developed to numerous technologies for handling and pumping must from storage tanks to presses, or other storage tanks. However, generally some amount of mixture of solids and liquids tends to remain in the bottom of a tank. As this residual must has a very high solids content, it is removed manually using shovels or rakes.

A significant trend in production of higher quality wines has been to segregate separate lots of wine from fermentation through bottling using small tanks. The separate fermentation of relatively small lots, on the order of about one hundred fifty gallons to 1000 gallons of must, may be intended to market wines with distinct vineyard designations, or to select lots for blending after fermentation, or aging, as well as to conduct production scale experimentation with different strains of wine yeast, malolactic bacteria or aids to fermentation.

However, the handling of separate small lots of grapes, must and eventually wine tends to be problematic being time and labor intensive, particularly the transfer of must to a press. As the winemaker strives to maintain separate identity of each lot during the operation, transfer pumps should be cleaned before and after use. Further, the manual labor to remove the remaining solids from a tank is considerable when compared with the volume of liquid transferred quickly by pumping operations.

Additionally, prior methods of pumping wine always present some risk of spillage loss, which in U.S. bonded wineries is accounted for in compliance records for the Bureau of Alcohol, Tobacco and Firearms.

Small volume rectangular plastic bins have become popular as vessels for primary fermentation, as they can be manipulated by forklift trucks designed for lifting and tilting rectangular bins so as to dump out the contents. One example of such a forklift vehicle is the “LIFTMASTER BIN DUMPER”, manufactured by Malavac Inc. of Fresno, Calif. 93725. However, rectangular bins are largely unsatisfactory as fermentation vessels for a number of reasons. First, it is extremely difficult to seal the rectangular bins such that a slight positive pressure of carbon dioxide, generated during fermentation, continues to blanket the wine, prevented oxidation, as well as to prevent spoilage by exposure to bacteria transmitted by fruit flies. The rectangular containers are even less suitable for storage of the substantially fermented must or wine to serve as vessels for secondary fermentation, as well as the completely fermented wine during storage, settling and aging. Thus, unless the winemaker intends to blend of small batches of wine after the primary fermentation, the winery would need to maintain an inventory of both rectangular bins and small fermentation vessels, imposing both an additional expense and increasing the storage space demands.

Accordingly, there is a need for an improved method of storing, fermenting and transferring grapes, must, grapes juice and wine so as to avoid setting up and tearing down pumps, pump lines, and performing manual operations.

It is therefore a first object of the present invention to provide a wine tank that can be conveniently emptied of both solids and liquids without pumping, yet is suitable for both the primary and secondary stages of fermentation, as well as the storage of the wine that results therefrom.

### SUMMARY OF INVENTION

In the present invention, the first object is achieved by providing a substantially circular tank capable of excluding air via a lid, top or other air tight closure, the tank being adapted for lifting and tilting by more than 90 degrees so as to empty the entire contents into another vessel or conveyor, such as the hopper of a press.

A second aspect of the invention is characterized in that the substantially circular tank is configured with forklift skids below the tank and various combinations of external fixtures such that the tank is secured in the pivot frame of a forklift during the tilting operation used to dump or pour the contents into another vessel.

Yet another aspect of the invention to provide a process wherein the must can be directly transferred from the tank or storage vessel to a press, and a press juice resulting therefrom is directly transferred to a comparable size and shape tank or storage vessel.

Accordingly, the inventive tank and methods provide the winery with many benefits that are convenient for production of small separate batches. By maximizing gravity transfer of must and wine in winery space is conserved as well as pumping must, partially fermented grape juice and wine eliminated labor intensive multiple cleaning steps of intermediate storage vessels; pump lines etc. An additional benefit is the minimized potential for spillage and other losses.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is an elevation showing a rectangular bin loaded (A) into the pivot frame attachment for a forklift vehicle configured for lifting and tilting (B) rectangular containers. FIG. 1(C) is a plan view of a rectangular bin secured in the pivot frame of FIG. 1A.

FIG. 2 A is an elevation illustrating a first embodiment of the inventive tank,

FIG. 2B is a plan view of FIG. 2A.

FIG. 3 A is a plan view illustrating an alternative embodiment of the inventive tank. FIG. 3B is the elevation of FIG. 3A.

FIG. 4 is a plan view illustrating an alternative embodiment of the inventive tank as secured in an alternative pivot frame attachment for a forklift vehicle configured for lifting and tilting of the pivot frame.

FIG. 5 is a plan view illustrating an alternative embodiment of the inventive tank as secured in an alternative pivot frame attachment for a forklift vehicle configured for lifting and tilting

FIG. 6 is a flow chart illustrating steps in using the inventive tank of FIG. 2 for transferring must into a grape press.

FIG. 7 is a plan viewing illustrating the position of tanks corresponding to steps 1-4 of FIG. 6, including the use of the inventive tank of FIG. 2 for transferring either grape must, juice or wine into another storage tank.

FIG. 8 is a plan viewing illustrating several of the step 5 of FIG. 6,

FIGS. 9A and 9B are elevations of alternative lids or covers for the inventive tanks.

FIG. 10A is an elevation illustrating another embodiment of the inventive tank, whereas FIG. 10B is an elevation taken orthogonal to FIG. 10A. FIG. 10C is the plan view of FIG. 10A and FIG. 10B.

### DETAILED DESCRIPTION

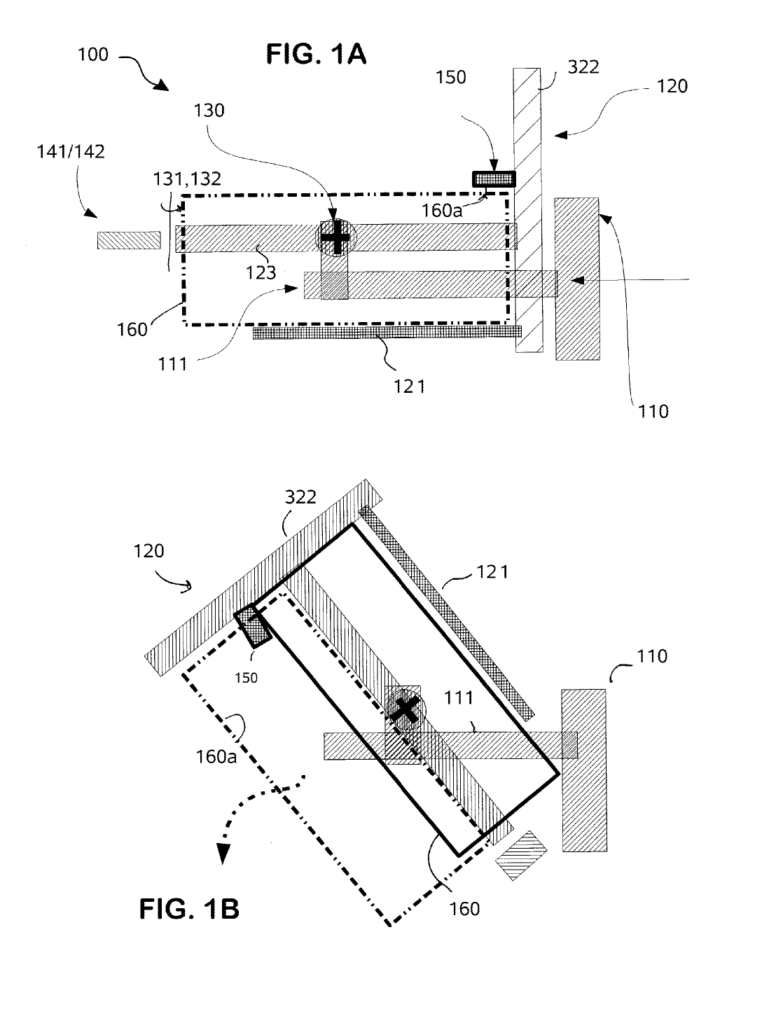

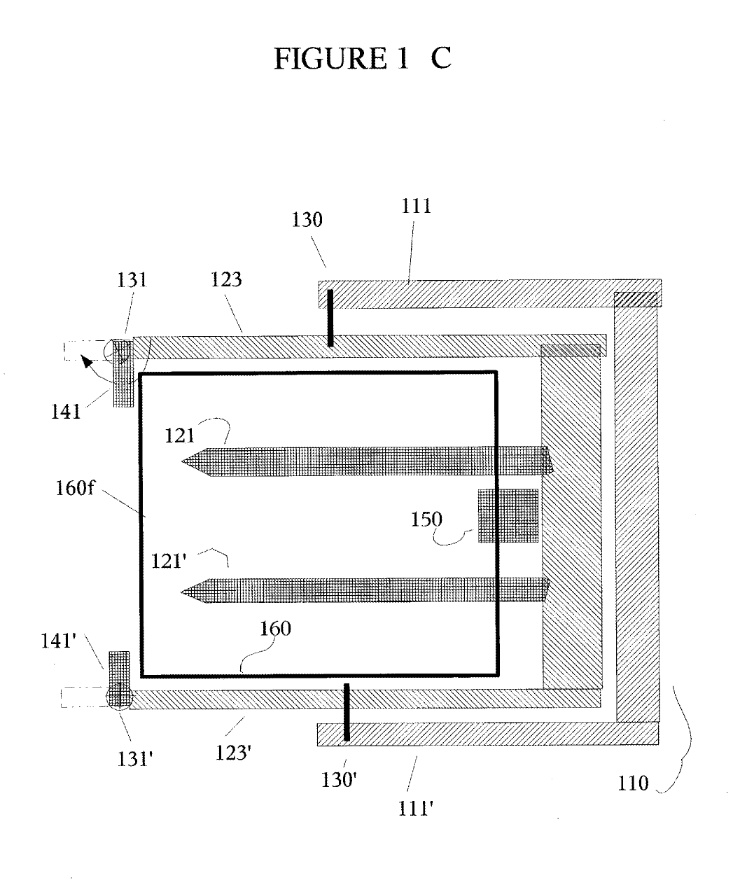

A convenient and efficient device for transferring fruits, crushed fruit, or any liquid solid slurry between containers is a forklift truck adapted for grasping a rectangular box or bin with an open top having lateral dimensions of about 4′×4′ with a height of about 2′ to 4′. FIG. 1A is an elevation of a pivot frame 100 having a chassis 110 for securing to the elevation lift of a fork lift truck. The rectangular box 160, shown in FIGS. 1B and C can be sitting on either palette jack type platform, or have open slits or is slightly elevated to provide an aperture to slide the forks lift tines or blades 121, 121′ under the bottom of the box. The forklift truck (not shown in this FIG.) is capable not only of lifting the rectangular box more than ten feet in the air, but also tilting the box forward via a pivot grip mechanism 120 attached to chassis 100 at rotation axis 130, as shown in the elevation of FIG. 1B. Preferably pivot frame 100 has a remotely actuated pivoting grip mechanism 120 for holding, lifting and securely tilting rectangular bins. The forklift operator controls both a gripping actuator, for securing the bin, and a rotary actuator for dumping the bin, as well as the elevator lift that displaces chassis 100 in the vertical direction.

The pivot grip mechanism 120 has a vertical section 322 adjacent chassis 110, including gripper arms 123 that extend laterally from opposing sides of vertical section 322 to straddle the box 160 as shown in the plan view of FIG. 1B. Arms 123 of pivot grip mechanism 120 are connected to fixed arms 111 and 111′ that also extend laterally from chassis 110, being connected at the rotation axis 130 of pivot frame 100. Further, pivot grip mechanism 120 further comprise forks 211, 211′ connected to the lower portion of vertical section 322 of grip mechanism 120, such that fork tines 121, 121′ and arms 123, 123′ remain parallel when the pivot grip mechanism is rotated about axis 130.

As the rectangular box 160 would otherwise slide away from forks tines 121, 121′ that were initially used for lifting, the pivot grip mechanism 120 also provides hands 141 and 141′ to restrain the forward sliding motion of box 160. As shown in FIG. 1A, hands 141, 141′ extend outward parallel to the gripper arms 123, 123′ and fork tines 121, 121′ prior to loading box 160. Thus, as shown in FIG. 1C when the hands 141, 141′ are in the open, that is dashed line position, this permits the lateral movement of pivot frame 120 to insert fork tines 121, 122 below box 160. Thus, prior to lifting or rotating box 160 hands 141, 141′ rotate about axis 131 and 131′, becoming secured perpendicular to gripper arms 123, 123′ to face the front side 160f of box 160. The hands 141 and 141′ need not actually apply physical force to the box 160 at this stage, as they are essentially a sliding restraint for the pivoting stage in FIG. 1B. Further, in select embodiments the pivot grip mechanism 120 optionally comprises one or more angle stop brackets 150 mounted on vertical section 322. The angle stop brackets 150 thus extend horizontally so as to restrain the top edge 160a of the rectangular box during the pivoting stage in FIG. 1B. Thus, as shown in FIG. 1B, absent hands 141, 141′ and angle stop 150 box 160 would slide off forks tines 121, 121′ of pivot grip mechanism 120, as indicated by the dashed line representation.

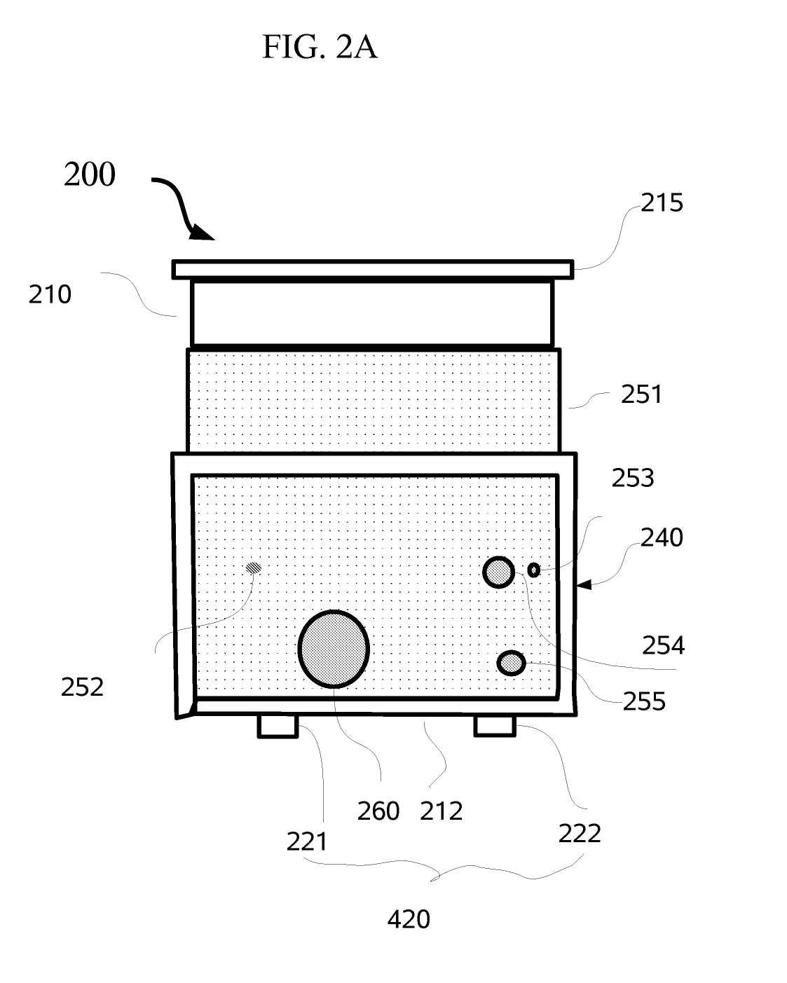

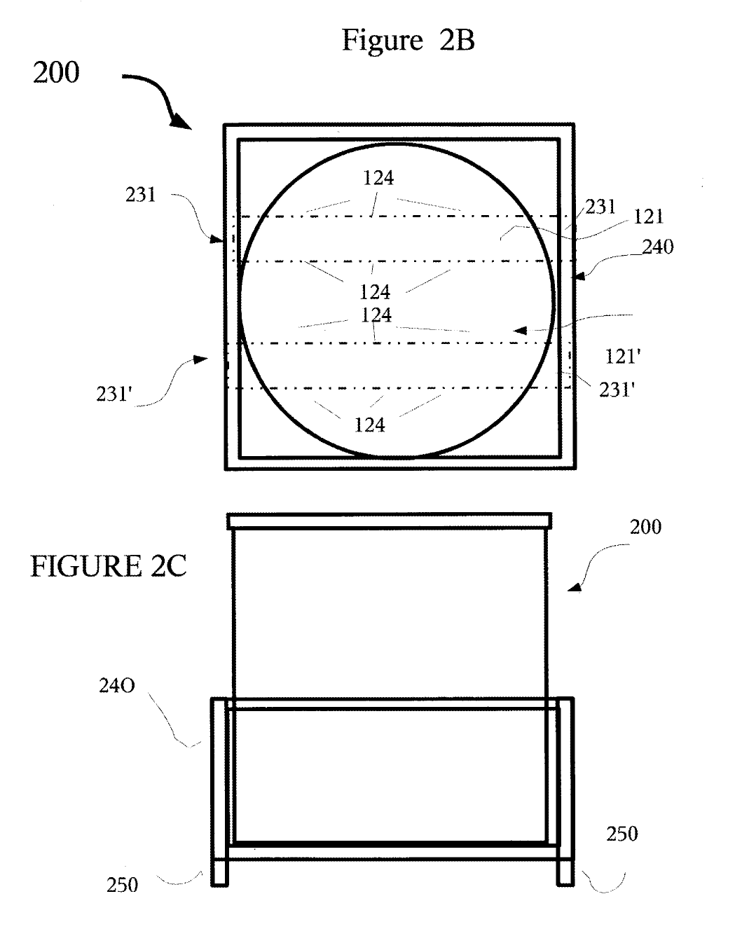

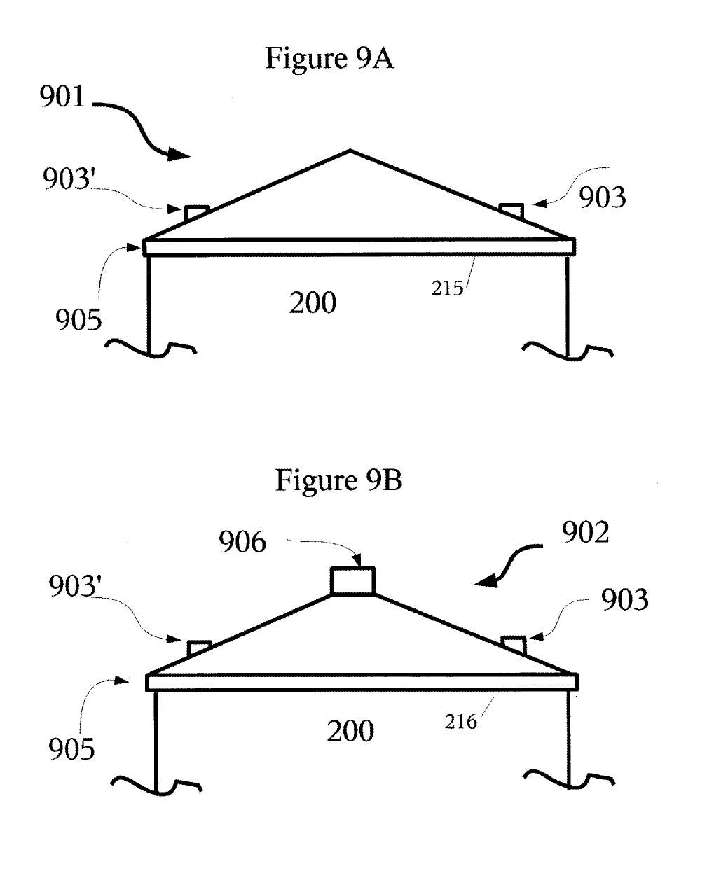

FIGS. 2A and 2B illustrates a first embodiment of an inventive wine tank suitable for lifting, tilting and dumping the contents with the forklift pivot attachment shown in FIG. 1. Wine tank 200 has an external rectangular frame 240 having substantially the same external dimensions as the conventional rectangular storage bin, but a cylindrical storage vessel 210. The storage vessel portion 210 is open at the top wherein a circular upper rim 215 provides hoop strength reinforcement and may receive various lids for sealing as will be further described with respect to FIG. 9.

As the storage vessel portion 210 of wine tank 200 is substantially cylindrical, external frame 240 provides a convenient mating surface for angle stop 150 and hands 141 and 141′, whose function is illustrated and described with respect to FIG. 1. The rectangular frame width and height are selected in accordance with the design of the pivot frame 120 so as to present a flat surface in horizontal alignment with handles 141, 141′ intended to restrain the front of the box during the tilting operation. In a corresponding fashion, the top of the rectangular frame is optionally substantially the same height as the conventional rectangular box, such that the angle stop 150 of FIG. 1 also restrains tank 200 when while it is being tilted to empty the contents therefrom.

Thus the diameter of the cylindrical tank is preferably the same or smaller than rectangular bin 160 of FIG. 1, that is typically less than about 4 feet. However, the cylindrical storage vessel 210 of tank 200 can have a larger diameter above frame 240 or extend upward to provide higher storage capacity. Typically, the tank will have a total height of between about 5 to 8 feet to provide a capacity of about 200 to about 800 gallons. Further, wine storage tanks of the instant invention are preferably fabricated from stainless steel. However, the wine storage tanks of the instant invention are optionally construction of alternative materials, such as polyolefins, polyethylene, fiberglass and the like.

Tank 200 also includes a pair of rectangular fork lift receiving tubes 221 and 222 that form a forklift skid 420 disposed below the bottom of tank 200. The skid 420 is in contact with the ground such that tubes 221 and 222 are positioned to receive fork tines inserted to moving the tank or transfer its contents. The use of fork lift receiving tubes 221 and 222 is a preferred embodiments, as it eliminates the need for angle stop bracket 150.

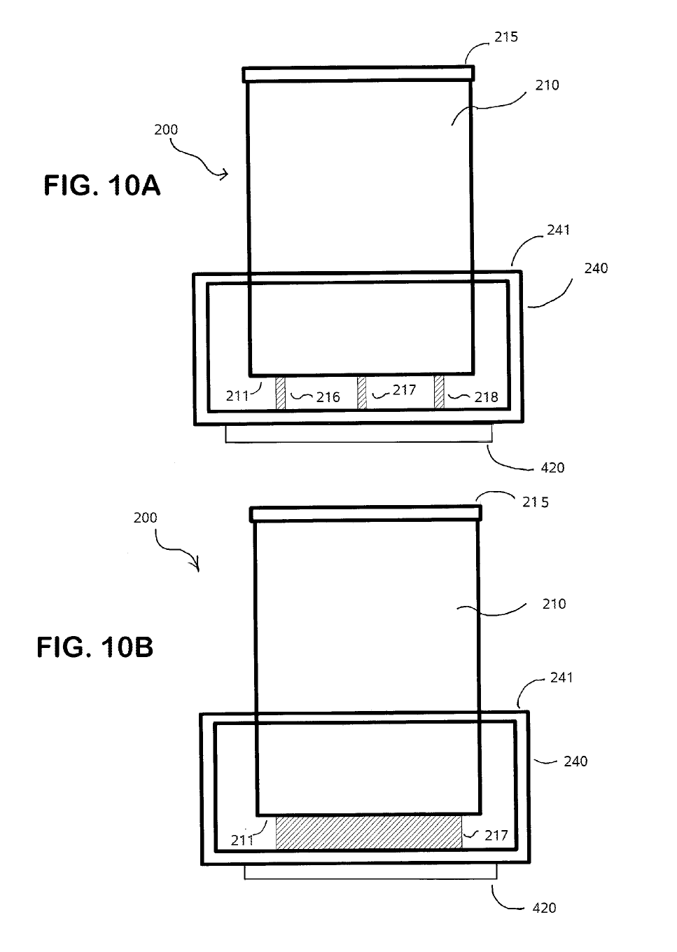

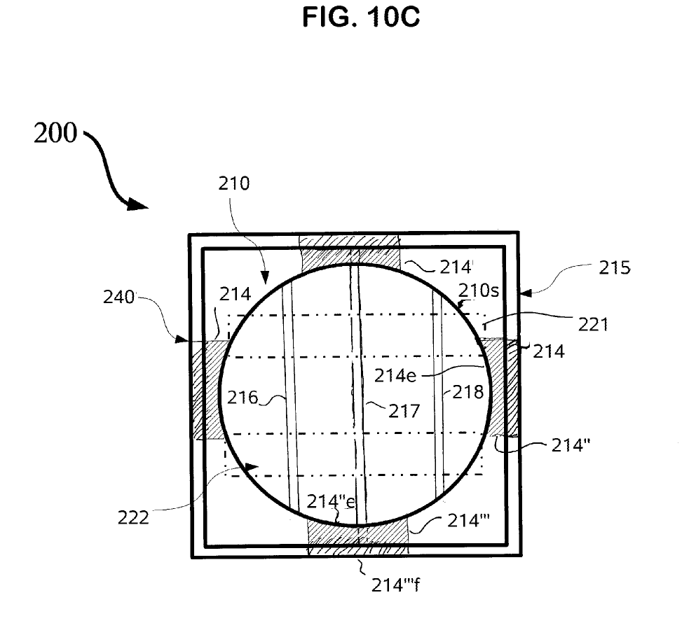

FIG. 10 illustrate yet another embodiment in which tank 200 comprises a substantially cylindrical storage vessel 210 attached to a surrounding rectangular frame 215. FIG. 10 A is an elevation illustrating the connection of the bottom 211 of storage vessel 210 to frame 215 by welding to a sequence of vertically disposed bars 216, 217 and 218. The orthogonal elevation of FIG. 10B illustrates the central vertically disposed bar 217 extending to substantially across the diameter of storage vessel 210 and thus, along with bar 216 and 218, providing reinforcing support to the bottom surface 211 of vessel 210. A more preferred embodiment is illustrated via the plan view of FIG. 10C in which horizontally disposed flat bar stock 214, 214′, 214″ and 214′″ is welded, or otherwise connected, to the sides of storage vessel 210, being centered about each of the four sides of the top frame edge 241. The edge 214e of the flat bar welded to the tank's side 210s has a concave shape to conform with the cylindrical tank wall whereas the opposing side 214f is linear and extends to reach the top edge 241 of frame 240. Thus one or more of horizontal flats 214, 214′, 214″ or 214″″ are optionally deployed to secure storage vessel 210 to frame 240 via a weld, bolt and like methods of mechanical coupling.

Further in another embodiment of the inventive tank forklift skids 420 are welded to the bottom edges of frame 240 at arrows 231 and 232, corresponding to the edges of tubes 221 and 222 respectively. Further, the bottom 212 of tank 200 is welded to the top of fork lift receiving tubes 221 and 222 at arrows 123 and 124 respectively.

Alternatively, as shown in FIG. 2C frame may optionally have legs 250 that extend downward corresponding in length to vertical walls of fork tong receiving tubes, with angle stop 150 providing vertical restraint via secure connection to the pivot frame when the tank is inverted.

Deployment of tank 200 in FIGS. 2A and 2B, as well as related embodiments, simplifies winery operations, as the conventional forklift pivot accessory of FIG. 1 is sufficient for rectangular fruit bins and cylindrical tanks, avoiding the need to modify, change or stock alternative pivot frames for forklift trucks. Thus as the process described herein eliminates a need to store both rectangular boxes and cylindrical tanks, as well as additional pumps, hoses, and the subsequent washing, a substantial portion of a temperature controlled storage facility of a winery can be utilized for wine production and storage, leaving minimal access aisles for the forklift truck.

Further in another embodiment of the inventive tank forklift skids 420 are welded to the bottom edges of frame 240 at arrows 231 and 232, corresponding to the edges of tubes 221 and 222 respectively. Further, the bottom 212 of tank 200 is welded to the top of fork lift receiving tubes 221 and 222 at arrows 123 and 124 respectively.

Alternatively, as shown in FIG. 2C frame may optionally have legs 250 that extend downward corresponding in length to vertical walls of fork tong receiving tubes, with angle stop 150 providing vertical restraint via secure connection to the pivot frame when the tank is inverted.

Deployment of tank 200 in FIGS. 2A and 2B, as well as related embodiments, simplifies winery operations, as the conventional forklift pivot accessory of FIG. 1 is sufficient for rectangular fruit bins and cylindrical tanks, avoiding the need to modify, change or stock alternative pivot frames for forklift trucks. Thus as the process described herein eliminates a need to store both rectangular boxes and cylindrical tanks, as well as additional pumps, hoses, and the subsequent washing, a substantial portion of temperature controlled storage facility of a winery can be utilized for wine production and storage, leaving minimal access files for the forklift truck.

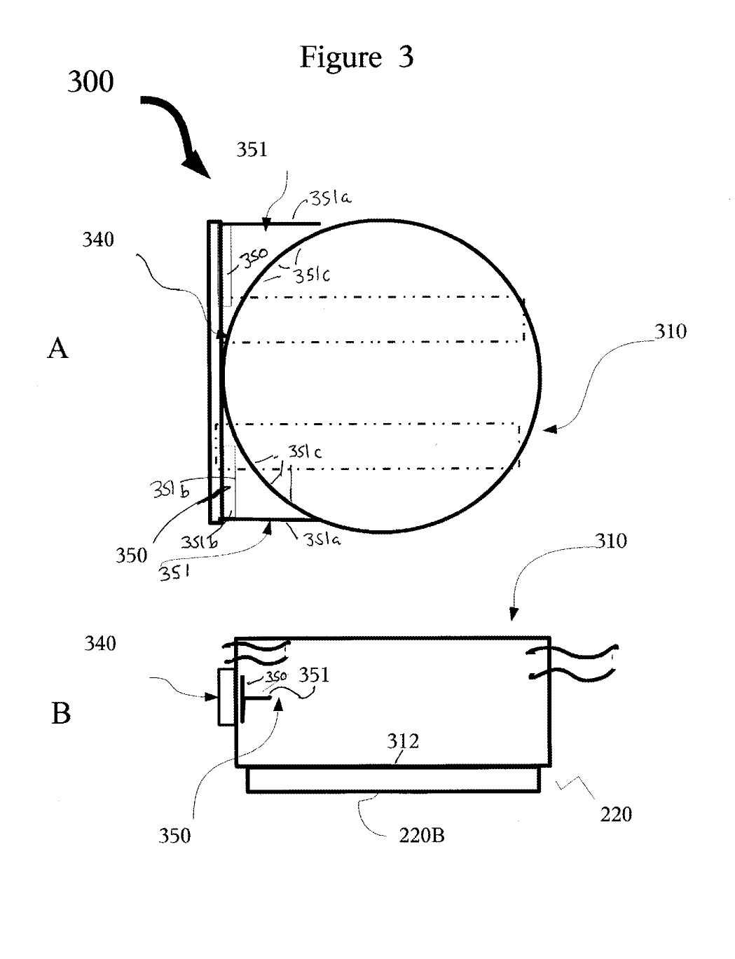

FIG. 3A illustrates in plan view an alternative embodiment of the inventive tank 300 wherein the vertical walls of the tank 300 that otherwise have cylindrical curvature have a flat plate or bars 340 attached thereto so as to conform with a external dimensions of the rectangular box at the nominal position of handle 141, 141′ in FIG. 1. Flat plat or bar 340 is secured to storage vessel portion 310 of tank 300 via t-shaped bracket 350. Horizontal portion 351 of T-bracket 350 has straight edges 351a and 351b on two sides with the third edge 350c curved in substantial conformity to the external cross-sectional of storage vessel 310, such that it can be securely welded at edge 350c. Provided that the tank 300 is also provisioned with fork lift receiving tubes 221 and 222 securely fasted to the bottom of tank 300 the use of an angle stop 150 on pivot frame 120 is optional, as the bottom portion 220b of the skid tubes 220 will provide equivalent restraint when the tank is tipped or inverted.

In light of this disclosure, it will be appreciated that the pivot grip and forklift mechanism can be modified so as to accommodate a cylindrical tank with a minimum of the additional mating feature is placed thereon.

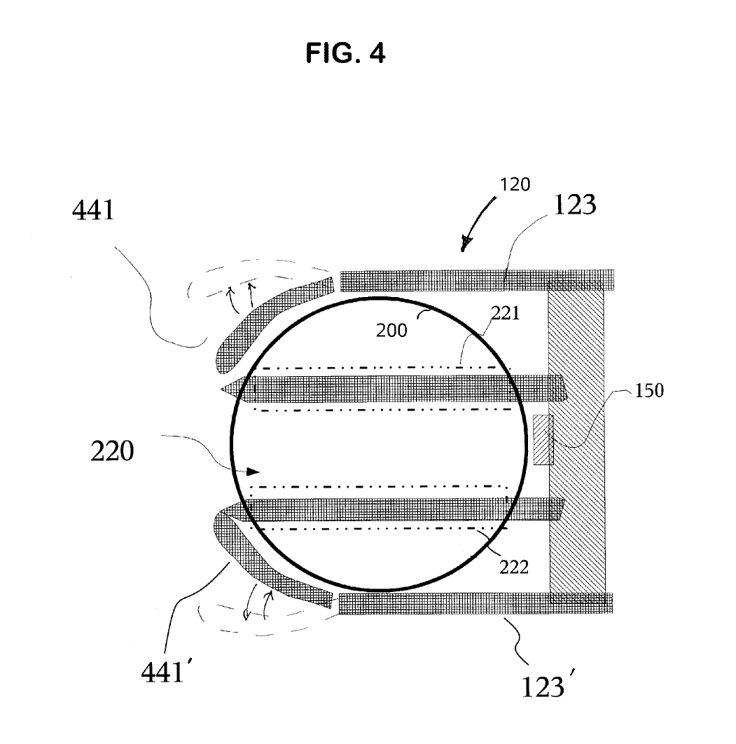

Thus, FIG. 4 is a plan view of a tank in such a modified pivot frames wherein the rotating handles disposed at the ends of the arms of front pivot frame (that restrain the front the rectangular bin) are replaced with curved arms 441 and 441′ that present vertical surfaces having that conform to the external shape of the storage vessel portion of tank 310, as their radius of curvature is substantially equal to that of the cylindrical tank, or about one half the separation distance of arms 123 and 123′, which is comparable to the tank diameter. To the extent that each of the forks enters a separate rectangular channel 221 and 222 secured to the bottom of tank 220, the use of additional restraining brackets on the pivot frame are optional.

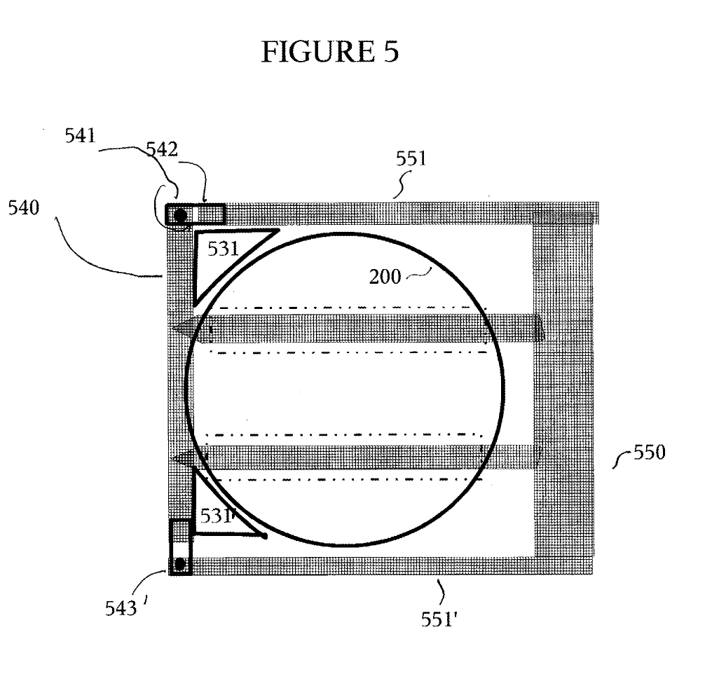

FIG. 5 is a plan view of yet another embodiment of a modified pivot frame for use with a cylindrical tank. In this embodiment the forward restraint provided by hands 141, 141′ in FIG. 1 or 441 and 442 in FIG. 4 need not be remotely or mechanically actuated. The pair of hands may be replaced by a restraining bar 540 that connects the ends of arms 551 and 551′. The restraining bar freely rotates about axis 541 (via either link 542 as shown, or a conventional hinge) for manually position in front of tank 200, bar 540 can be secured with a pin 543 to arm 551′ of pivot frame 550. Further, restraining bar optionally has curved fillets 531 and 531′ with a wide vertical surface that wrap or conform to the cylindrical shape of tank 200, as hands 441 and 441′ in FIG. 4. Alternatively, bar 540 can be a single linear segment in the case of the tank embodiments illustrated in FIGS. 2 and 3.

Alternatively, the form of the physical restraining device that connects the ends of arms 551 and 552 is optionally a chain, hook, block or alternative fastener on one or both arm ends.

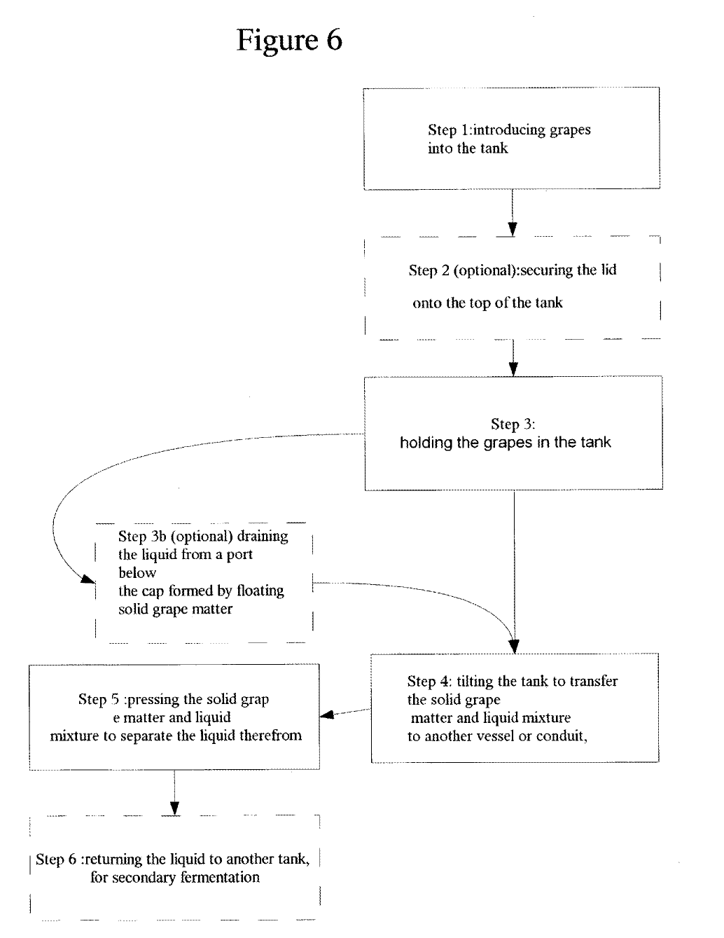

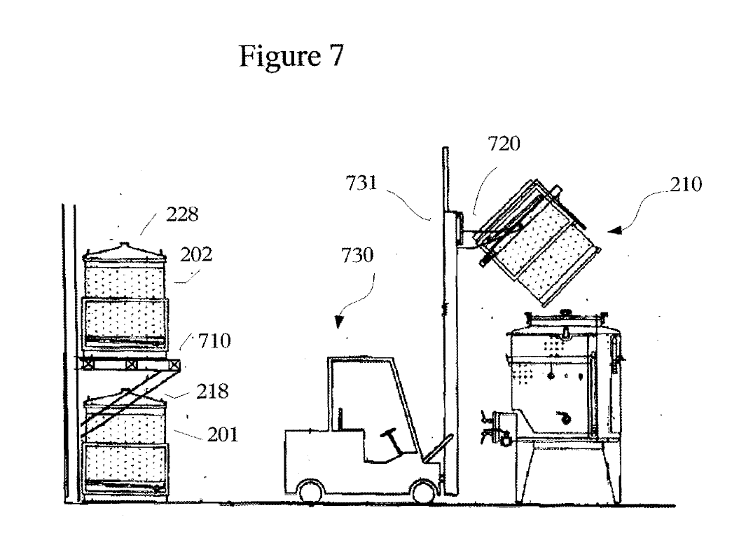

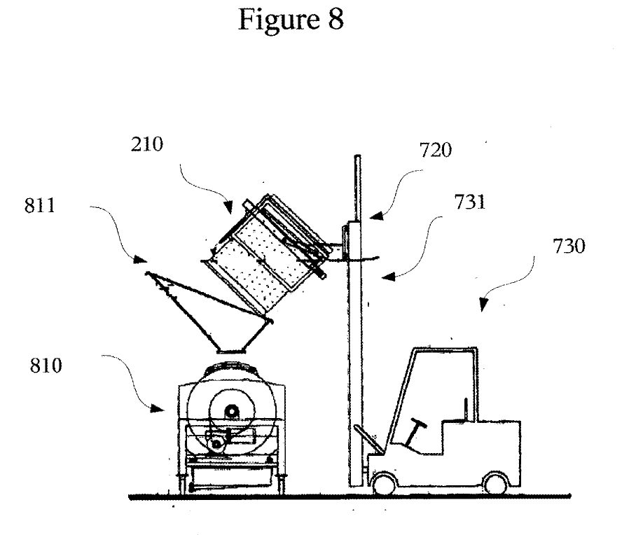

FIGS. 7 and 8 generally illustrate the use of the inventive tanks and pivot frame, or any combination thereof, for transferring either grape must, juice or wine into another storage tank, being representative of the various embodiments described with respect to FIG. 2-5. FIG. 6 is a flow chart characterizing the process steps whereas FIGS. 7 and 8 illustrates selected steps of the process in FIG. 6

Following the flow chart in FIG. 6 selected steps of a process for using fermentation tanks are illustrated in the elevations of FIG. 7 and FIG. 8. Thus in FIG. 7 either of tanks 201 or 202 represents tanks at stage 3 wherein the first steps was introducing crushed grapes, a mixture of crushed grapes and whole grapes or whole grapes in tank 100, and holding such grapes mixture in the tanks. Further as lid 218 has been secured on the top of tank 201 (with tank 202 covered by lid 228) the second step of covering the tank is also complete. Note that tank 202 is disposed above tank 201, having been placed on shelf 710, for example by forklift truck 730. The vertical displacement of tank 202 above tank 201 represents a preferred embodiment enabling the optional step 3b in FIG. 6 of draining the free flowing liquid from tank 202 to tank 201. This optional liquid transfer step is readily accomplished with a short hose (not shown) connected to a drain port, racking port or a tube that has an inlet section below the cap of floating grape skins that readily forms on the top of fermenting grape must, thus separating a substantial portion of the liquid from the solid grape matter prior to step 4 (shown in FIG. 8). In addition to comprising removable sealable lids, alternative embodiments of the inventive tank include outfitting with additional components on their vertical surfaces as shown in FIG. 2A, that is a large diameter clean out port on the vertical sides 260, medium diameter racking port 254 for receiving an internal rotating racking arm (not shown), medium diameter drain port 255, smaller diameter sampling port 253, thermal control jacket 251 and thermowell 252.

FIG. 8 is an elevation of winery operations of step 4 of FIG. 6 after tank 202 has been removed from shelf 710 via forklift truck 730. Forklift truck 730 lifts tank 202 via elevator section 721 above the hopper 811 of horizontal bladder press 810. Accordingly, the rotation of pivot grip mechanism 720 secured to elevation section 721 essentially pours the remaining solid and liquid contents of tank 202 into hopper 811. Thus step 5 of pressing the solid grape matter and liquid mixture by press 800 is completed as hopper 811 further conveys this mixture to the press section there under.

FIG. 9 is an elevation of alternative lids or covers for any of the inventive tanks in FIGS. 2-5 that may be used to seal or protect the contents during storage as shown in FIGS. 7 and 8 for tanks 201 and 202. In FIG. 9A lid 901 has a circular rim 905 comprising a vertically extending side edge to fit over the open top of tank 200, covering rim 215. Handle 903 and 903′ are disposed on the sloping sides of lid 901, lid 901 having a conical upper surface with its apex extending above the top of the tank.

In FIG. 9B lid 902 has a circular rim 905 comprising a vertically extending side edge to fit over the open top of tank 200, covering rim 216. Handle 903 and 903′ are disposed on the sloping sides of lid 902. The sloping sides form a conical upper surface with a cylindrical portal 906 disposed at the apex thereof. The cylindrical portal is a conventional feature for connecting a fluid transfer hose, fermentation locks (that permit the carbon dioxide gas formed in fermentation to freely escape), and the like. Accordingly, either lid 901 or 902 may be held in place by gravity, or with optional clamps (not shown) so that the entire lid can be readily removed via handles 903 and 903′ at any time before tilting tank 200 to pour or dump its contents. Alternatively, either of lids 901 or 902 may be secured to the vertical side wall of the cylinder with a hinge.

Thus, using the lids of FIG. 9, the inventive tanks can be placed either on floor or stacked on shelves as well as contain solid grapes, crushed grapes, grape juice, partially fermented grape juice or wine as either an initial, intermediary or final step in the wine making process. Alternatively, the must can be first fermented in the inventive tanks under a nonporous tarp, and then emptied directly into the hopper of a vertical or horizontal grape press. As the hopper or press mechanism provide temporary storage capacity until the press is activated, the same tank (or indeed a pre-cleaned tank of the same dimensions) can be placed to receive the fluid output of the press, either directly or via a liquid pump attached to press output. Accordingly, the filled tank can then be fitted with sealable lid for further fermentation, settling or wine storage. Conveniently the tank can be returned to the same location in the winery as in step 3 after completing step 5 of FIG. 6.

Further, as the wine tank is in an inverted position immediately after its contents are transferred to another vessel or the press, the tank can be conveniently cleaned by rinsing with a hose, thus minimizing the use of water in winery operations.

As the tank volume will be reduced between steps 3 and 5 of FIG. 6, due to the removal of grape solid it is preferable to either completely fill the tank with similar wine or grape juice, or alternatively to covert the tank into a variable volume storage vessel by deploying an adjustable internal seal formed from a disc, and optionally omitting the fixed sealable lids of FIG. 9, as such lids rest or a seated on the upper wall of the tank. Thus, in using the tanks as a variable storage vessel a disc having an outer diameter slightly smaller than the inner diameter of the tank is inserted under the fixed lid. The disc is inserted into the tank so as to float or otherwise come into substantial contact with the wine. A flexible rubber ring around the periphery of the disc provides a substantially air tight seal to the wine as if fills the annular gap created by the difference in diameter between the disc and the tank interior diameter. The flexible rubber ring facilitates the vertical displacement of the disc so as to accommodate a variable volume of liquid without leaving an open head space between the liquid and the top of a sealed vessel.

Thus, as the process described herein eliminates a need to store both rectangular boxes and cylindrical tanks, as well as additional pumps, hoses, and the subsequent washing thereof, a substantial portion of the temperature controlled storage facility of a winery can be utilized for wine production and storage, providing access aisles for the forklift truck.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A fermentation vessel comprising:
a) a tank for liquid containment having a bottom and vertical sides of substantially circular cross section at an upper opening,
b) at least one vertical bar or plate disposed tangentially in secure attachment to a vertical side of the tank.

2. A fermentation vessel according to claim 1 further comprising:
a) fork lift skids disposed below the bottom of said tank, in secure attachment thereto.

3. A fermentation vessel according to claim 2 wherein said fork lift skids have a long axis perpendicular to said vertical panel.

4. A fermentation vessel according to claim 2 wherein said fork lift skids are tubes

5. A fermentation vessel according to claim 1 wherein the vertical panel is provided by a rectangular frame having a square upper portion, a square lower portion in which the upper and lower portions are connected by 4 vertical edge and the inner diameter of the frame is substantially the same as the outer diameter of the vessel.

6. A fermentation vessel according to claim 1 further comprising one of more portals disposed on the vertical surfaces selected from the group consisting of a drain port, racking port, clean out port, a racking port for receiving an internal rotating racking arm, sampling port, and a thermowell.

7. A fermentation vessel according to claim 1 further comprising a thermal control jacket.

8. A fermentation vessel according to claim 1 further adapted to receive a lid for air tight closure of the upper opening of said tank.

9. A fermentation vessel according to claim 1 further comprising a lid having a portal for receiving a fermentation lock.

10. A fermentation vessel according to claim 1 further comprising a lid and a fermentation lock disposed in said lid.

11. A fermentation vessel comprising:
a) a tank for liquid containment having a bottom and vertical sides of substantially circular cross section at an upper opening,
b) a rectangular frame having a square upper portion, a square lower portion in which the upper and lower portions are connected by 4 vertical edge and the inner diameter of the frame is substantially the same as the outer diameter of the vessel,
c) fork lift skids disposed below the bottom of said tank, in secure attachment to at least one of said tank and said rectangular frame.

12. A fermentation tank according to claim 11 in which said fork lift skids are disposed at the bottom of said rectangular frame whereby the fermentation tank rests on said skids.

13. A fermentation tank according to claim 11 in which said fork lift skids are disposed at the bottom of said rectangular frame and said tank is connected to at least one of said skids and said skids are connected to said frame.

14. A fermentation tank according to claim 11 in which said fork lift skids are disposed at the bottom of said rectangular frame and said tank is connected is connected to a least a portion of the rectangular frame.

15. A fermentation tank according to claim 13 in which said tank is connected to said skids.

16. A fermentation tank according to claim 13 in which said tank is connected to said fork lift skids via a plurality of vertically extending plates that are attached to the bottom of the tank at the upper edge thereof and to the top of the forklift skids at the lower edge thereof.

17. A fermentation vessel according to claim 13 further comprising one or more portals disposed on the vertical surfaces selected from the group consisting of a drain port, racking port, clean out port, a racking port for receiving an internal rotating racking arm, sampling port, and a thermowell.

18. A fermentation vessel according to claim 13 further comprising a thermal control jacket.

19. A fermentation vessel according to claim 13 further adapted to receive a lid for air tight closure of the upper opening of said tank.

20. A fermentation vessel according to claim 13 further comprising a lid having a with a fermentation lock disposed therein.
